(19) United States
(12) Patent Application Publication
(10) Pub. No.: US 2025/0045347 A1
(43) Pub. Date: Feb. 6, 2025

(54) SPATIOTEMPORAL DYNAMIC SYSTEM SOFT SENSING METHOD FOR AUTOMATICALLY DETERMINING PARTIAL DIFFERENTIAL EQUATION (PDE) STRUCTURE

(71) Applicant: DALIAN UNIVERSITY OF TECHNOLOGY, Dalian, Liaoning (CN)

(72) Inventors: Ximing SUN, Dalian, Liaoning (CN); Aina WANG, Dalian, Liaoning (CN); Pan QIN, Dalian, Liaoning (CN); Hongxin LI, Dalian, Liaoning (CN)

(21) Appl. No.: 18/713,854

(22) PCT Filed: Aug. 17, 2023
(86) PCT No.: PCT/CN2023/113498

§ 371 Date: May 28, 2024

(30) Foreign Application Priority Data
Aug. 3, 2023 (CN) 202310974079.7

(51) Int. Cl. G06F 17/13

(52) U.S. Cl. CPC G06F 17/13

(57) ABSTRACT

The present invention provides a spatiotemporal dynamic system soft sensing method for automatically determining a partial differential equation (PDE) structure and belongs to the technical field of soft sensing of neural networks. Firstly, a loss function for training a coupled physics-informed neural network with a recurrent prediction mechanism is constructed to obtain a solution and a driving source which satisfy a PDE used for describing spatiotemporal industrial processes; secondly, differential operator candidates are obtained by an automatic differentiation method, and an appropriate PDE structure is selected from the differential operator candidates to accurately describe the spatiotemporal industrial processes; and finally, the soft sensing result is verified using heat diffuse phenomena and actual vibration processes. The CPINNRP-AIC is suitable for soft sensing methods of multi-class dynamic systems with spatiotemporal dependence, can achieve the effective acquisition of key variable values for high-end complex equipment such as an aero-engine in operation processes.

### TECHNICAL FIELD

The present invention belongs to the technical field of soft sensing based on neural networks and relates to a spatiotemporal dynamic system soft sensing method for automatically determining a partial differential equation (PDE) structure.

### BACKGROUND

With the continuous improvement of the industry level, high-end industrial equipment such as an aero-engine are becoming more complex and larger, and the possibility of failure has also become higher, so the safety and reliability of industrial equipment is crucial. During actual operation, complex industrial equipment have numerous key variables containing information with respect to the health status of the equipment, and the acquisition for key variable values is the basis to ensure the safe and stable operation of the equipment. The measurements for key variables are difficult to acquire through sensors due to the limitation of extreme environment, such as high temperature, high pressure, and installation sites. Accordingly, a huge threat to the reliable, safe, and stable operation of high-end industrial equipment are posed.

As a virtual sensing technology, soft sensing is used for estimating key variables by utilizing easy-to-measure process variables and mathematical models. Therefore, for key process variables of high-end industrial equipment, soft sensing technology plays a key role in ensuring the safety and reliability of the equipment when sensors are not available. The classical observer-based methods use time series data to implement soft sensing. However, the methods cannot easily handle spatial information. PDEs are used for describing industrial processes involving multiple variables. For example, heat equations are used for modeling heat diffuses through a given region; wave equations are used for describing various wave phenomena; Maxwell's equations are used for describing how changes in charges, currents and fields produce electric fields and magnetic fields; and Navier-Stokes (NS) equations are used for describing the motion of viscous fluid substances. Therefore, PDE is a natural idea as a candidate for a soft sensing mathematical model for industrial processes with spatiotemporal dependence. An appropriate PDE structure is of great significance in optimization, control, and prediction in real industry. It should be noted that the above idealized PDE focuses on a single phenomenon or mechanism. However, complex industrial processes often involve multiple disciplines. For example, internal combustion engines involve thermodynamics and fluid mechanics. The integration of several idealized PDEs into a system of equations is a intuitive physic-informed method in industrial processes. However, prior-determined PDE structures cannot always model practical industrial processes well. Therefore, constructing PDEs with proper structures for practical situations is crucial for developing soft sensors.

In recent years, it is an effective method to use machine methods to develop a data-physics-hybrid model to solve forward and inverse problems in PDEs. A physics-informed neural network (PINN) is introduced to solve PDEs by sparse measurement and prior physical knowledge (Raissi M, Perdikaris P, Karniadakis G E. Physics-informed neural networks: A deep learning framework for solving forward and inverse problems involving nonlinear partial differential equations [J]. Journal of Computational physics, 2019, 378:686-707.). In the PINN framework, the physics-informed loss is used for regularizing the data-loss. Accordingly, an unknown PDE structure including differential operators or unknown driving sources makes it infeasible to solve PDEs using PINN. Therefore, some works focus on learning PDEs and solving PDEs with unknown driving sources in recent years. The investigation shows some recent advances in solving PDEs with unknown driving sources in the PINN framework. Literature (M. Yang and J. T. Foster, “Multi-output physics-informed neural networks for forward and inverse pde problems with uncertainties,” Computer Methods in Applied Mechanics and Engineering, p. 115041, 2022.) shows that the functional forms of both a solution and a driving source are assumed to be unknown, where the measurement of the driving source can be obtained separately from that of the solution. Recent literature (H. Gao, M. J. Zahr, and J.-X. Wang, “Physics-informed graph neural galerkin networks: A unified framework for solving pde-governed forward and inverse problems,” Computer Methods in Applied Mechanics and Engineering, vol. 390, p. 114502, 2022) proposes a graph neural network to solve PDEs with unmeasurable driving sources, where the driving sources are assumed to be constant. Despite some success in the above research, the independent measurement of the driving sources and the use of constant sources to describe dynamic systems are infeasible for practical situations. Other advances show that the PINN is a promising framework for identifying PDEs from spatiotemporal data. Recent work (H. Xu, H. Chang, and D. Zhang, “Dl-pde: Deep-learning based data-driven discovery of partial differential equations from discrete and noisy data,” arXiv preprint arXiv:1908.04463, 2019. and Z. Chen, Y. Liu, and H. Sun, “Physics-informed learning of governing equations from scarce data,” Nature communications, vol. 12, no. 1, p. 6136, 2021.) combine deep learning through neural networks with data-driven PDE identification through sparse regression. Work (Z. Long, Y. Lu, and B. Dong, “Pde-net 2.0: Learning pdes from data with a numeric-symbolic hybrid deep network,” Journal of Computational Physics, vol. 399, p. 108925, 2019.) identifies PDEs by a combination of numerical approximation of differential operators by convolution and symbolic multi-layer neural networks for model discovery. Although the abovementioned works have achieved some success in PDE identification, the form of PDEs driven by unknown driving sources is not taken into account. Literature (Sun Ximing, Wang Aina, Qin Pan, “Coupled Physics-informed Neural Networks for Solving Vibration Displacement Distribution of Finite Line Under the Action of Unknown External Driving Forces” [P]. Liaoning Province: CN116050247A, 2023-5-2) uses idealized PDEs to realize effective soft sensing of industrial processes with spatiotemporal dependence under the conditions that the form of driving sources with spatiotemporal dependence is unknown and the independent measurement are not available, and the gaps often exist between idealized PDEs and practical situations. Therefore, an effective soft sensing algorithm for industrial processes with spatiotemporal dependence that have completely unknown PDE structure and driving sources is a problem under investigation.

### SUMMARY

In view of the existing problems, the present application proposes a soft sensing technology (CPINNRP-AIC) combining a coupled physics-informed neural network (CPINN) with a recurrent prediction (RP) mechanism and the Akaike's information criterion (AIC), which is used for obtaining a PDE structure for describing industrial processes with spatiotemporal dependence, so as to obtain a solution and a driving source. The method provided by the present invention can obtain an appropriate soft sensing result to ensure optimization, control and prediction of the system, which is of great significance to ensure the actual, safe and stable operation of high-end industrial equipment such as an aero-engine. The CPINNRP-AIC proposed by the present invention is used for soft sensing of industrial processes with spatiotemporal dependence that have completely unknown PDE structure and is verified using heat equations describing heat diffusion phenomena and data sampled from an aero-engine involute spline couplings fretting wear experiment platform, and the effectiveness of the proposed method is verified using evaluation criteria of a root mean square error (RMSE) and a Pearson correlation coefficient (CC).

To achieve the above purpose, the present invention adopts the following technical solution:

A spatiotemporal dynamic system soft sensing method for automatically determining a PDE structure is a soft sensing technology combining a CPINN with an RP mechanism and the AIC, comprising the following steps: firstly, constructing a loss function for training a CPINN with an RP mechanism to obtain a solution and a driving source which satisfy a PDE used for describing spatiotemporal industrial processes; secondly, obtaining differential operator candidates using an automatic differentiation technology; thirdly, selecting an appropriate PDE structure from the differential operator candidates using the AIC to accurately describe the spatiotemporal industrial processes; and finally, verifying that the method proposed by the present invention can obtain a feasible soft sensing result by using heat diffusion phenomena and actual vibration processes. The method comprises the following specific steps:

A PDE used for describing industrial processes with spatiotemporal dependence has the following general form:

$${u}_{t} ( x , t ) + N [ u ( x , t ) ] = g ( x , t ) , x ∈ Ω , t ∈ [ 0 , T ] \qquad ( 1 )$$

x is a space variable,/is a time variable and in the initial state when t=0, u: [symbol] ^{d}× [symbol] → [symbol] is solution to formula (1), i.e., a variable to be measured of industrial processes with spatiotemporal dependence, and the variable has spatiotemporal dependence; and g: [symbol] ^{d}× [symbol] → [symbol] is a driving source with a general form, i.e., the driving source has spatiotemporal dependence, including linearity, nonlinearity and steady state or dynamic state. Ω is open set space to which the space variable belongs, and ωΩ is the boundary thereof; and N is a series of differential operators.

The industrial processes with spatiotemporal dependence can be described by the following PDE with a general form when the exact PDE structure is unknown, i.e., the proposed CPINNRP-AIC is used for solving the following PDE:

$$Φ [ u ( x , t ) ] \cdot λ = g ( x , t ) , x ∈ Ω ⊆ {ℝ}^{d} , t ∈ [ 0 , T ] ⊂ ℝ , \qquad ( 2 )$$

Φ[·] is differential operator candidates of a series of partial differential operators, for example, uₜ,uₓ,uₓₓ,uₜₓ, which are assumed to be sufficient to fully include all the differential operators obtained by means of automatic differentiation, i.e., a series of states of industrial processes with spatiotemporal dependence changing over time and space.
The present invention is to learn to obtain a solution u and a driving source g that can approximately satisfy formula (1) from formula (2); and formula (2) can be written in a form of the following residual function:

$${f}_{N} ( x , t ) := Φ [ u ( x , t ) ] \cdot λ - g ( x , t ) . \qquad ( 3 )$$

When an external driving force g(x,t) is completely known, f_{N}(x,t) can be obtained directly by means of sparse regression. However, the unknown external driving force g(x,t), i.e., industrial processes under the action of the unknown external driving force, will cause the method for obtaining f_{N}(x,t) by means of sparse regression to be infeasible.

Therefore, the present invention proposes the CPINNRP-AIC to obtain a neural network-based solution satisfying the PDE in formula (1). The proposed CPINNRP-AIC comprises two phases: 1) the CPINNRP is for approximating u and g satisfying the PDE in formula (1); and 2) the AIC is for selecting an approximate combination of differential operators satisfying the PDE in formula (1). The CPINNRP is composed of NetU, NetG and NetU-RP, wherein NetU is for approximating u satisfying formula (1), NetG is for approximating g satisfying formula (1), and NetU-RP is for compensating for information loss caused by the discretization strategy with respect to t. The specific steps are as follows:

Step 1: constructing a loss function for training the CPINNRP.

Mountable hardware sensors in a whole domain Ω̅=Ω∪∂Ω are used to provide a training data set (x,t,u)∈D, wherein the mountable hardware sensors comprise a mountable sensor in the interior Ω of the domain and a mountable sensor at the boundary ωΩ of the domain. The dataset is divided into D_{B} ∪D_{I} and D_{B} ∩D_{I}=Ø. D_{B} and D_{I} are randomly sampled from boundary and initial conditions of Ω and the interior Ω, respectively, D_{B} represents a training set sampled from the mountable sensor at the boundary ωΩ of the domain and the initial time, and D_{I} represents a training set sampled from the mountable sensor in the interior Ω of the domain; x,t,u represent a space variable, a time variable and a variable to be measured with spatiotemporal dependence, respectively; and D represents the training dataset. A corresponding collocation point set E=E_{B} ∪E_{I} is acquired according to the positions of the available sensors, wherein (x,t)∈E, and E represents the whole domain collocation point set; E_{B} represents a collocation point set corresponding to the training dataset D_{B}; and E_{I} represents a collocation point set corresponding to the training dataset D_{I}. The CPINNRP-AIC is trained using a data-physics-hybrid loss function shown in formula (4).

$$MSE = {MSE}_{DN} + {MSE}_{PN} \qquad ( 4 )$$

wherein MSE_{DN} and MSE_{PN} represent a data loss function and a physics-informed loss function with an undetermined exact PDE structure in the given formula (2), respectively, and the physics-informed loss function contains a physics-informed part with an undetermined combination of differential operators.

The MSE_{DN} is obtained by the following formula:

$${MSE}_{DN} = 1 ∖ card ( D ) {\sum }_{( x , t , u ) ∈ D} {( \hat{u} ( x , t ; {Θ}_{U} ) - u ( x , t ) )}^{2} \qquad ( 5 )$$

wherein û(x,t;Θ_{U}) is a function of the network NetU with Θ_{U} being a set of parameters to approximate u satisfying formula (1), and card(·) is the cardinalty of the set ·.
The MSE_{PN} is obtained by the following formula:

$${MSE}_{PN} = 1 ∖ card ( E ) {\sum }_{( x , t ) ∈ E} {( {\hat{f}}_{N} ( x , t ; {Θ}_{U} , λ ) )}^{2} \qquad ( 6 )$$

Further, \hat{f}_{N}(x,t;Θ_{U},λ) is obtained from Φ[û(x,t;Θ_{U})]·λ with an undetermined combination of differential operators, as shown in formula (7):

$${\hat{f}}_{N} ( x , t ; {Θ}_{U} , λ ) = Φ [ \hat{u} ( x , t ; {Θ}_{U} ) ] \cdot λ - \hat{g} ( x , t ; {Θ}_{G} ) \qquad ( 7 )$$

wherein ĝ(x,t;Θ_{G}) is a function of the network NetG with Θ_{G} being a set of parameters to approximate g satisfying formula (1); λ represents a parameter vector; and \hat{f}_{N}(x,t;Θ_{U},λ) represents a residual function form of formula (3) parameterized by (Θ_{U},λ).

Step 2: optimizing the coupled CPINNRP-AIC with an undetermined exact PDE structure using a hierarchical training strategy.

Considering the interdependence between the network NetU and the network NetG in formula (4), the hierarchical training strategy is proposed to train the CPINNRP-AIC by means of iterative transmission of parameters, wherein \hat{Θ}_{U}^{(k+1)} and \hat{Θ}_{G}^{(k+1)} at are used for approximating u and g, respectively. k represents the number of iteration steps. The purpose of the hierarchical training strategy is to solve the following two coupled optimization problems.

$$\begin{matrix}{\hat{Θ}}_{G}^{( k + 1 )} = {arg min}_{{Θ}_{G}} \{ {MSE}_{DN} ( {\hat{Θ}}_{U}^{( k )} ) + {MSE}_{PN} ( {Θ}_{G} ; {\hat{Θ}}_{U}^{( k )} , {\hat{λ}}^{( k )} ) \} \\ = {arg min}_{{Θ}_{G}} {MSE}_{PN} ( {Θ}_{G} ; {\hat{Θ}}_{U}^{( k )} , {\hat{λ}}^{( k )} )\end{matrix} \qquad ( 8 )$$

$$and$$

$$( {\hat{Θ}}_{U}^{( k )} , {\hat{λ}}^{( k + 1 )} ) = {arg min}_{( {Θ}_{U} , λ )} \{ {MSE}_{DN} ( {Θ}_{U} ) + {MSE}_{PN} ( {Θ}_{U} , λ ; {\hat{Θ}}_{G}^{( k + 1 )} ) \} , \qquad ( 9 )$$

wherein MSE_{PN}(Θ_{G};\hat{Θ}_{U}^{(k)},λ^{(k)}) and MSE_{PN}(Θ_{U};λ,\hat{Θ}_{G}^{(k+1)}) are the physics-informed parts with an undetermined combination of differential operators, and MSE_{PN}(Θ_{G};\hat{Θ}_{U}^{(k)},\hat{λ}^{(k)}) is obtained based on (\hat{Θ}_{U}^{(k)},\hat{λ}^{(k)}); and MSE_{PN}(Θ_{U},λ;\hat{Θ}_{G}^{(k+1)}) is obtained from \hat{Θ}_{G}^{(k+1)});

To compensate for the information loss caused by discretization strategy with respect to t, the delayed prediction through time of the CPINN output û(x,t;\hat{Θ}_{CPINN}) and the hardware sensors are used as part of the NetU-RP input, i.e., the input of NetU-RP comprises three parts: x, t and the delayed prediction through time of û(x,t;\hat{Θ}_{CPINN}) or the delayed prediction through time of hardware sensors. û(x,t;\hat{Θ}_{CPINN}) and the output of the hardware sensors are selected in an either-or way, i.e., when the hardware sensors can be installed at the collocation point (x,t), the output delay of the measurements is used as the input of the collocation point; and when the measurements of the hardware sensors cannot be obtained at the collocation point (x,t), the delay of û(x,t;\hat{Θ}_{CPINN}) is used as the input of the collocation point. Therefore, Φ[û(x,t;\hat{Θ}_{U})]·\hat{λ} with an undetermined combination of differential operators and g satisfying formula (1) are obtained.

Step 3: using the AIC to select an appropriate combination of differential operators satisfying formula (1).

For idealized models, such as heat equations, wave equations, Maxwell's equations and NS equations, many interference factors will exist in complex industrial processes. Therefore, a gap often exists between the ideal situation and the practical situation. For this purpose, the AIC is considered for evaluating and selecting Φ[û(x,t;\hat{Θ}_{U})]·\hat{λ} containing an undetermined combination of differential operators.

$$AIC = 2 p + nln ( {\hat{σ}}^{2} ) , \qquad ( 10 )$$

wherein p is the number of differential operators contained in evaluation of Φ[û(x,t;\hat{Θ}_{U})]·\hat{λ}, n is the size of the data set, and \hat{σ}²=MSE_{DN}. The selected combination of differential operators achieves a appropriate PDE structure, i.e., a combination with the minimum AIC value is selected from all the candidates Φ[û(x,t;\hat{Θ}_{U})]·\hat{λ} as a PDE model that is ultimately used for approximating formula (1). The details of the hierarchical optimization coupling strategy and model selection of the CPINNRP-AIC are shown in algorithm 1.

Algorithm 1: CPINNRP-AIC for hierarchical optimization coupling strategy and model selection:
(1) Initialization: letting k=0, initializing the network NetU and the network NetG, and setting the maximum number k of iteration steps to M as the stop criterion for loop;
1.1) Obtaining a training data set (x,t,u)∈D and a collocation point set (x,t)∈E;
1.2) Randomly generating initialized parameter sets Θ_{U}⁽⁰⁾ and Θ_{G}⁽⁰⁾ for the network NetU and the network NetG;
1.3) Conducting the following loop when k<M:
(a1) Obtaining \hat{Θ}_{G}^{(k+1)} by solving the optimization problem (8), and at this moment, Φ[û(x,t;\hat{Θ}_{U}^{(k)}]·\hat{λ}^{(k)} in MSE_{PN} comes from the iteration result (\hat{Θ}_{U}^{(k)},\hat{λ}^{(k)}) of the previous step;
(b1) Obtaining (\hat{Θ}_{U}^{(k+1)},\hat{λ}^{(k+1)}) by solving the optimization problem (9), called (\hat{Θ}_{CPINN},\hat{λ}^{(k+1)});
(c1) k=k+1;

Judging whether the stop criterion is met: if yes, ending the loop, and returning to u(x,t;\hat{Θ}_{CPINN}); if no, returning to step (a1), and conducting an iterative transmission process of parameters Θ_{U} and Θ_{G} to solve the optimization problems (8) and (9);
(2) Initialization: letting k=0, and initializing the network NetU-RP using \hat{Θ}_{CPINN};
2.1) Besides x and t, inputting the output u(x,t;\hat{Θ}_{CPINN}) of the CPINN and the measurement to NetU-RP in an either-or way by recurrently delayed through time, depending on whether the hardware sensors are available;
2.2) Conducting the following loop when k<M:
(a2) Training NetU-RP using formula (4);
2.3) Judging whether the stop criterion of loop is met: if yes, ending the loop, and returning to differential operator candidates Φ[û(x,t;\hat{Θ}_{U})]·\hat{λ} obtained by means of automatic differentiation; if no, returning to step (a2).
2.4) Calculating the AIC value from the combination Φ|û[(x,t;\hat{Θ}_{U})]·\hat{λ} of differential operator candidates using formula (10);
2.5) Selecting a combination of differential operators with the minimum AIC value as a final model for approximating formula (1).

Step 4: evaluating the performance of the CPINNRP-AIC method in the spatiotemporal dynamic system soft sensing method for automatically determining a PDE structure, i.e., evaluating the u and g performance of \hat{Θ}_{U}^{(k+1)} and \hat{Θ}_{G}^{(k+1)} obtained using the trained CPINNRP-AIC for approximating formula (1).

Using the RMSE and the CC as evaluation criteria to evaluate the performance of the CPINNRP-AIC.

$$RMSE = \sqrt{\frac{1}{\vert T \vert} {\sum }_{( x , t ) ∈ T} {( u ( x , t ) - \hat{u} ( x , t ) )}^{2}} \qquad ( 11 )$$

wherein the RMSE is used for evaluating the distance between the ground truth and the prediction, |T| is the cardinality of the test collocation point set (x,t)∈T, and u(x,t) and û(x,t) represent the ground truth and the corresponding solution based on the neural network, respectively. The smaller the value of the RMSE is, the better the performance of the CPINNRP-AIC is.

$$CC = \frac{cov ( u ( x , t ) , \hat{u} ( x , t ) )}{\sqrt{Var u ( x , t )} \sqrt{Var \hat{u} ( x , t )}} \qquad ( 12 )$$

wherein CC is used for evaluating the similarity between ground truth and the prediction. The CC is the correlation coefficient of u(x,t) and û(x,t), and cov(u(x,t), û(x,t)) is covariances of u(x,t) and û(x,t). Var u(x,t) and \sqrt{Var û(x,t)} are variances of u(x,t) and û(x,t), respectively. The closer the value of the CC is to 1, the better the performance of the CPINNRP-AIC is. For the RMSE and the AIC, snapshots as well as values of the evaluation criteria for the full time period are given.

Without loss of generality, the industrial processes with spatiotemporal dependence which have an unknown exact PDE structure and action of the driving sources can be described by formula (2), typically including: (a) heat equations describing heat diffusion phenomena: the heat of the interior of the finite line is subjected to heat diffuses under the drive of the heat source, and heat equations with sources describing the actual temperature distribution of the interior of the finite line, if the measurements of the heat source generated inside an aero-engine in the actual operation process cannot be obtained and the specific heat diffusion phenomena cannot be described using idealized heat equations, heat equations with an unknown exact PDE structure are solved in order to obtain the temperature distribution at any point; and (b) wave equations describing wave phenomena: vibration displacement distribution of the finite line, which is described by wave equations, if the spline shaft of an aero-engine vibrates during operation and is affected by various driving sources, a variety of industrial processes with spatiotemporal dependence are involved, and the vibration process cannot be precisely modeled by using the idealized wave equations, it is necessary to solve wave equations with an unknown exact PDE structure to obtain vibration displacement distribution at any point for spline shaft.

The present invention has the following beneficial effects:

The present invention proposes a new PINN, called CPINNRP-AIC, which is used for approximating a solution and a driving source which satisfy the PDE used for describing industrial processes with spatiotemporal dependence. In the present invention, firstly, the CPINNRP is used to approximate the solution satisfying the PDE, and the driving source satisfying the PDE is obtained. Then, a data-physics-hybrid loss function for training the CPINNRP is proposed, wherein the physics-informed par involves an undetermined combination of differential operators. Therefore, AIC is used for selecting an appropriate combination of differential operators. The proposed CPINNRP-AIC is a data-driven method which is used for achieving an appropriate PDE structure and a neural network-based solution satisfying PDE. Finally, the feasibility and effectiveness of the CPINNRP-AIC for soft sensing of industrial processes with spatiotemporal dependence that have a completely unknown PDE structure are verified using heat equations and the data sampled from aero-engine involute spline couplings fretting wear experiment platform. The performance of the CPINNRP-AIC is evaluated by using RMSE and CC, and the results tend to 0 and 1, respectively, indicating that the CPINNRP-AIC has good performance as a soft sensing method. This method is soft sensor for dynamic systems with spatiotemporal dependence that have an unknown PDE structure. The proposed CPINNRP-AIC is suitable for soft sensing technologies of multi-class dynamic systems with spatiotemporal dependence, including heat diffusion phenomena in practical situations and wave phenomena in actual vibration processes. The CPINNRP-AIC proposed by the present invention can achieve the effective acquisition of key variable values of high-end complex equipment such as an aero-engine in operation processes, so as to provide guarantee for the good control performance of high-end industrial equipment and the stability of safe operation, thus having practical engineering application significance and economic values.

### DESCRIPTION OF DRAWINGS

FIG. 1 is a histogram of the size of AIC of the number of typical model terms of heat equations describing heat diffuses;

FIG. 2 shows prediction and ground truth corresponding to a snapshot at t=3;

FIG. 3 shows prediction and ground truth corresponding to a snapshot at t=7;

FIG. 4 shows original signals in the time domain sampled from sensor 1;

FIG. 5 shows original signals in the time domain sampled from sensor 2;

FIG. 6 shows original signals in the time domain sampled from sensor 3;

FIG. 7 shows original signals in the time domain sampled from sensor 4;

FIG. 8 is a histogram of the size of AIC of the number of typical model terms of wave equations describing actual vibration processes.

### DETAILED DESCRIPTION

The present invention is further described below in combination with specific embodiments.

The present invention provides a spatiotemporal dynamic system soft sensing method for automatically determining a PDE structure. The method solves a PDE by using the CPINN with an RP mechanism and the AIC, the PDE is used for describing industrial processes with spatiotemporal dependence, and the exact PDE structure comprises a combination of differential operators and unknown driving sources. Specific embodiments discussed are only used for illustrating the implementation mode of the present invention, not used for limiting the scope of the present invention. The implementation mode of the present invention is described below in detail in conjunction with the drawings, specifically comprising the following steps:

To theoretically demonstrate the effectiveness of the CPINNRP-AIC, embodiment 1 first illustrates the implementation mode of the present invention using numerical simulation of one-dimensional heat equations.

Embodiment 1: heat diffusion phenomena of a one-dimensional finite line under the impact of an unknown heat source with one end being a heat insulation end and the other end being a heat dissipation end in practical industrial systems, i.e., the measurement is the temperature distribution at any point (x,t). Therefore, embodiment 1 uses the CPINNRP-AIC to solve the one-dimensional heat equation with Neumann boundary conditions and an unknown exact model structure, to obtain a soft sensing result.

To obtain a training set and a testing set, the PDEs of the following forms are given to describe heat diffusion phenomena of the one-dimensional finite line under the impact of a heat source with one end being a heat insulation end and the other end being a heat dissipation end.

$$\frac{\partial u}{\partial t} = {a}^{2} \frac{{\partial }^{2} u}{\partial {x}^{2}} + g ( x , t ) , 0 < x < L , t > 0 \qquad ( 13 )$$

$$u {\vert}_{t = 0} = ϕ ( x ) , 0 ⩽ x ⩽ L$$

$$u {\vert}_{x = 0} = 0 , \frac{\partial u}{\partial x} {\vert}_{x = L} = 0 , t > 0$$

The heat diffusivity is α=1, u(x,t) is the temperature in any point (x,t), the length of the finite line is L=π, the initial temperature is

$$ϕ ( x ) = sin \frac{x}{2} ,$$

the heat source is

$$g ( x , t ) = sin \frac{x}{2} ,$$

and the analytical expression of temperature distribution is

$$u ( x , t ) = ( 4 - 3 {e}^{- \frac{t}{4}} ) sin \frac{x}{2} .$$

Considering the heat diffusion phenomena in the actual industrial system, the exact PDE structure and the heat source are unknown, and the measurement of the heat source cannot be obtained. A heat equation describing the temperature distribution of the one-dimensional finite line and having an unknown exact model and driving source is converted to a PDE in the residual form shown in formula (3).

$${f}_{N} ( x , t ) := Φ [ u ( x , t ) ] \cdot λ - g ( x , t ) . \qquad ( 14 )$$

Accordingly, CPINNRP-AIC comprises two phases: 1) the CPINNRP is for approximating u and g satisfying formula (13); and 2) the AIC is for selecting appropriate differential operators uₜ,uₓₓ. The CPINNRP is composed of NetU, NetG and NetU-RP, wherein NetU is for approximating u satisfying formula (13), Net (is for approximating u satisfying formula (13), and NetU-RP is for compensating for information loss caused by the discretization strategy with respect to t.

1. Constructing a loss function:

A training set is obtained from uniform random sampling in a system controlled by formula (13). In the present embodiment, the training set is obtained from uniform random sampling in [0,π]×[0,10], and contains 130 boundary and initial training data (x,t,u)∈D_{B}, including 10 initial condition training data, 60 left boundary condition training data, 60 right boundary condition training data, and 20 internal training data (x,t,u)∈D₁. 20 collocation points (x,t)∈E, and the structure of formula (13) is guaranteed by the collocation points. CPINNRP-AIC is trained using the loss function of formula (4). MSE_{DN} and MSE_{PN} represent data loss (5) and physics-informed loss (6), respectively, wherein MSE_{DN} is obtained by formula (5), û(x,t;Θ_{U}) is a function of the network NetU with Θ_{U} being a set of parameters; and MSE_{PN} is obtained by formula (6), ĝ(x,t;Θ_{G}) is a function of the network NetG with Θ_{G} being a set of parameters. MSE_{PN} corresponds to the physics-informed loss of formula (13) on a finite collocation point set (x,t)∈E, and Φ[û(x,t;Θ)]·λ involves an undetermined combination of differential operators to regularize u in the network NetU to satisfy formula (13).

2: Optimizing the coupled CPINNRP-AIC with an undetermined exact PDE structure using the hierarchical training strategy;

Considering the interdependence between the network NetU and the network NetG in the loss function MSE, the hierarchical training strategy is proposed. In many cases of practical application, for example, the exact expressions of the heat equations used for describing the heat diffusion phenomena of the interior of the aero-engine and the heat source g(x,t) cannot be obtained even by sparse measurement, the CPINNRP-AIC can be used to obtain \hat{Θ}_{U} and \hat{Θ}_{G} based on sparse measurement data D, to approximate u and g satisfying formula (13), respectively. Considering the interdependence between Θ_{U} and Θ_{G}, the estimation is made by means of interactive iteration. Assuming k as the existing number of iteration steps, the purpose of the hierarchical training strategy is to solve two optimization problems (8) and (9).

3. Using the AIC to select an appropriate combination of partial differential operators satisfying formula (13);

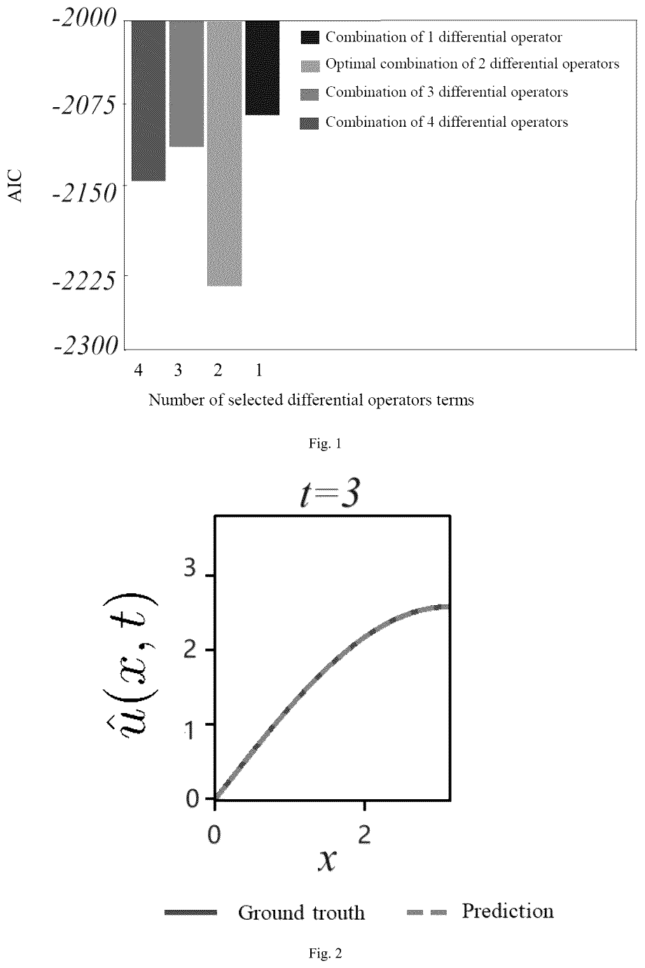

A gap often exists between the idealized heat equation model describing heat diffusion phenomena and the practical situation. For this purpose, the AIC is considered for carrying out model evaluation and selection, and for the heat diffusion phenomena, a first derivative with respect to the time variable is considered. The candidates are constructed as follows: Φ=[uₜ,uₓ,uₓₓ,uₓₜ]. The AIC in formula (10) is subsequently used for evaluating and selecting an appropriate combination from Φ. FIG. 1 is a histogram of the size of AIC of the number of typical model terms of heat equations describing the heat diffusion phenomena. The results show that the combination of uₜ and uₓₓ is a optimal combination of heat differential operators to describe the heat diffusion phenomena. The details of the hierarchical strategy for optimizing and coupling and model selection of the CPINNRP-AIC are shown in algorithm 1.

### Algorithm 1: Hierarchical Strategy for Optimizing and Coupling and Model Selection of CPINNRP-AIC

(1) Initialization: letting k=0, initializing the network NetU and the network NetG, and setting the maximum number k of iteration steps to M as the stop sriterion of loop;
1.1) Obtaining a training dataset (x,t,u)∈D and a collocation point (x,t)∈E;
1.2) Randomly generating initialized parameter sets Θ_{U}⁽⁰⁾ and Θ_{G}⁽⁰⁾ for the network NetU and the network NetG;
1.3) Conducting the following loop when k<M:
   (a1) Obtaining \hat{Θ}_{G}⁽⁺¹⁾ by solving the optimization problem (8), and Φû[(x,t;\hat{Θ}_{U}^{(k)}]·\hat{λ}^{(k)} in MSE_{PN} from the iteration result (\hat{Θ}_{U}^{(k)},\hat{λ}^{(k)}) of the previous step;
   (b1) Obtaining \hat{Θ}_{U}^{(k+1)},\hat{λ}^{(k+1)}) by solving the optimization problem (9), called (\hat{Θ}_{CPINN},\hat{λ}^{(k+1)});
   (c1) k=k+1;

Judging whether the stop criterion is met: if yes, ending the loop, and returning to u(x,t\hat{Θ}_{CPINN}); if no, returning to step (a1), and conducting an iterative transmission process of parameters Θ_{U} and Θ_{G} to solve the optimization problems (8) and (9);

(2) Initialization: letting k=0, and initializing the network NetU-RP using \hat{Θ}_{CPINN};

2.1) Besides x and t, inputting the output u(x,t;\hat{Θ}_{CPINN}) of the CPINN and measurement to NetU-RP in an either-or way by recurrently delayed through time, depending on whether the hardware sensors are available;

2.2) Conducting the following loop when k<M:

(a2) Training NetU-RP using formula (4);

2.3) Judging whether the stop criterion of loop is met: if yes, ending the loop, and returning to differential operator candidates Φ[û(x,t;\hat{Θ}_{U})]·\hat{λ} obtained by means of automatic differentiation; if no, returning to step (a2).

2.4) Calculating the AIC value from the combination Φ[û(x,t;\hat{Θ}_{U})]·\hat{λ} of differential operator candidates using formula (10);

2.5) Selecting a combination of differential operators with the minimum AIC value as a final model for approximating formula (13).

4. Evaluation of Performance

The RMSE of formula (11) is used to evaluate the soft sensing error of the proposed CPINNRP-AIC method in the heat diffuse system of the one-dimensional finite line with one end being a heat insulation end and the other end being a heat dissipation end, i.e., evaluating the performance of the CPINNRP-AIC method in solving a one-dimensional heat equation with Neumann boundary conditions and an unknown exact PDE structure. The RMSE of f_{N}(x,t) for the full time period is 5.658725e-03, and u(x,t) and û(x,t) represent an actual temperature value and a corresponding soft sensing temperature value, respectively. To further verify the performance of the CPINNRP-AIC, CC of formula (12) is used to further illustrate the similarity between the soft sensing temperature of the CPINNRP-AIC method and the actual temperature.

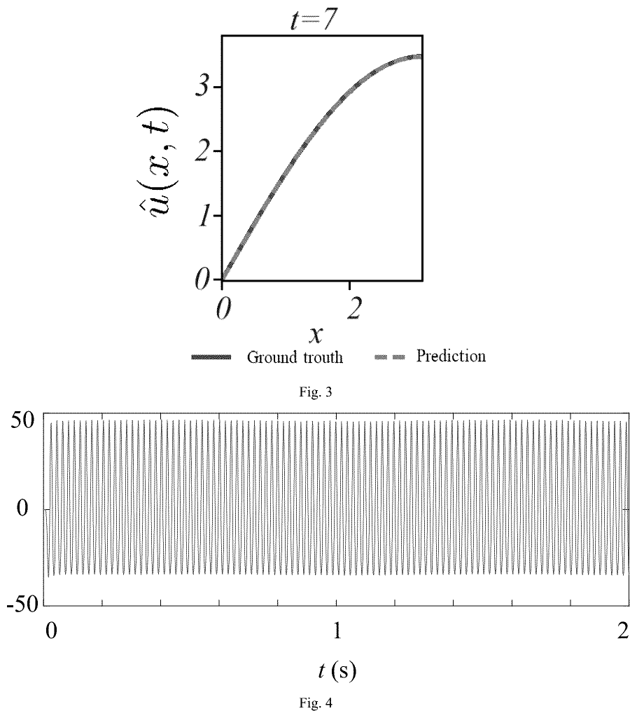

In the present embodiment, the relevant setting for the CPINNRP-AIC is that the number of hidden layers is 3 and each layer has 30 neurons. The magnitude of prediction is shown in FIG. 2, and the comparison between the prediction and ground truth of the snapshots at t=3 and t=7 is shown in FIG. 3 and FIG. 4, respectively. The evaluation criteria for prediction performance at t=3 and t=7 and for the full time period are shown in Table 1.

TABLE 1
Soft Heat Equations Sensing Performance of CPINNRP-AIC Based on
Unknown Exact in Heat Diffuses of One-dimensional Finite Line

| Evaluation Index | 3 | 7 | [0, π] × [0, 10] |
|---|---|---|---|
| RMSE | 1.058429e−03 | 1.531820e−03 | 2.195188e−03 |
| CC | 9.999997e−01 | 9.999991e−01 | 9.999980e−01 |

RMSE tends to 0 and the CC tends to 1 in Table, indicating that the CPINNRP-AIC in the present embodiment has better soft sensing performance based on the unknown exact heat equations in the heat diffuse system of the one-dimensional finite line.

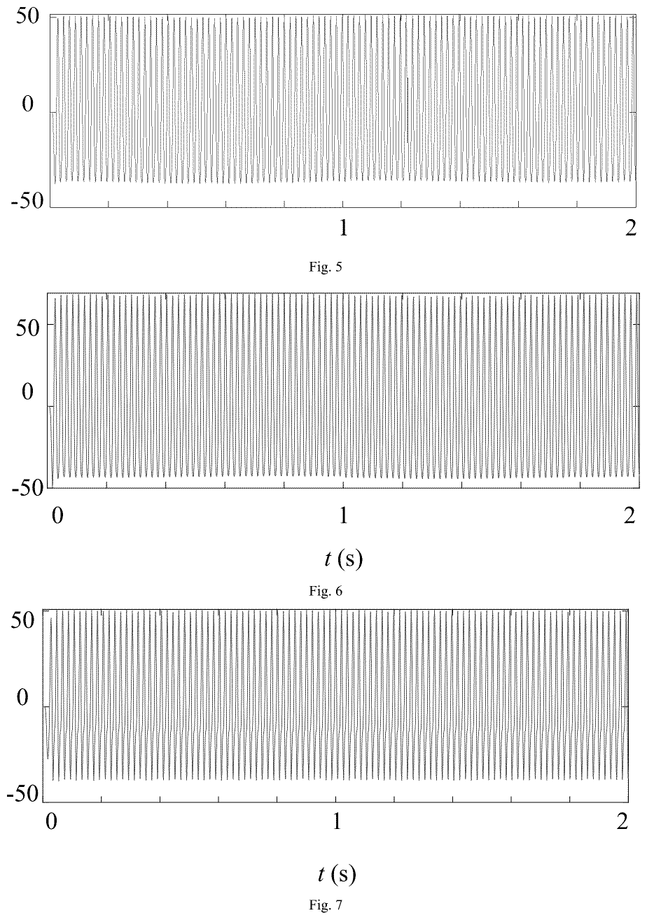

Embodiment 2: vibration phenomena of a one-dimensional finite line under the impact of an unknown driving force in practical industrial systems, i.e., the measurement is the vibration displacement distribution at any point (x,t). Therefore, embodiment 2 uses the CPINNRP-AIC to solve a one-dimensional wave equation with an unknown exact model structure, so as to obtain a soft sensing result. The feasibility and effectiveness of soft sensing with the CPINNRP-AIC are verified using actual data sampled from the aero-engine involute spline couplings fretting wear experiment platform. The training and testing data sets are sampled from displacement sensors 1-4 installed on the acro-engine involute spline couplings fretting wear experiment platform. The sampling conditions of the datasets shown in FIG. 4 to FIG. 7 are as follows: FIG. 4 shows vibration displacement data in the time domain measured from the sensor 1, FIG. 5 shows vibration displacement data in the time domain measured from the sensor 2, FIG. 6 shows vibration displacement data in the time domain measured from the sensor 3, and FIG. 7 shows vibration displacement data in the time domain measured from the sensor 4.
1) The working speed of a motor driver is 3000 r/min.
2) The sampling frequency is 2048 Hz with 4096 sampling points.

Considering the vibration process in the actual industrial system, the exact PDE structure for describing the vibration process is unknown, and the driving force cannot be measured. Accordingly, the CPINNRP-AIC can be considered as a soft sensors contains two phases: 1) the CPINNRP is for approximating the displacement u and the driving force g satisfying a PDE; and 2) the AIC is for selecting an appropriate PDE structure. The CPINNRP is composed of NetU, NetG and NetU-RP, wherein NetU is for approximating the displacement u satisfying the PDE, NetG is for approximating the driving force g satisfying the PDE, and Net-RP is for compensating for information loss caused by the discretization strategy with respect to t.

1. Constructing a loss function.

MSE_{DN} and MSE_{PN} represent data loss (5) and physics-informed loss (6) respectively. û(x,t;Θ_{U}) is a function of the network NetU with Θ_{U} being a set of parameters. MSE_{PN} is obtained by formula (5), ĝ(x,t;Θ_{G}) is a function of the network NetG with Θ_{G} being a set of parameters MSE_{PN} corresponds to the physics-informed loss on a finite collocation point set (x,t)∈E, and Φ[û(x,t;Θ)]·λ involves an undetermined combination of differential operators to regularize u in the network NetU to satisfy the displacement of PDE describing the vibration process.

2: Optimizing the coupled CPINNRP-AIC with an undetermined exact PDE structure using the hierarchical training strategy

Considering the interdependence between the network NetU and the network NetG in the loss function MSE, the hierarchical training strategy is proposed. The wave equation structure that actually describes the vibration phenomena of the acro-engine involute spline shaft cannot be obtained even by sparse measurement of the driving force, the CPINNRP-AIC can be used to obtain \hat{Θ}_{U} and \hat{Θ}_{G} based on sparse measurement data D_{I} to approximate the vibration displacement and the driving force respectively. Considering the interdependence between \hat{Θ}_{U} and \hat{Θ}_{G}, the estimation is made by means of interactive iteration. Assuming k as the existing number of iteration steps, the purpose of the hierarchical training strategy is to solve two optimization problems (8) and (9).

3. Using the AIC to select an appropriate combination of differential operators satisfying the PDE structure describing actual vibration processes;

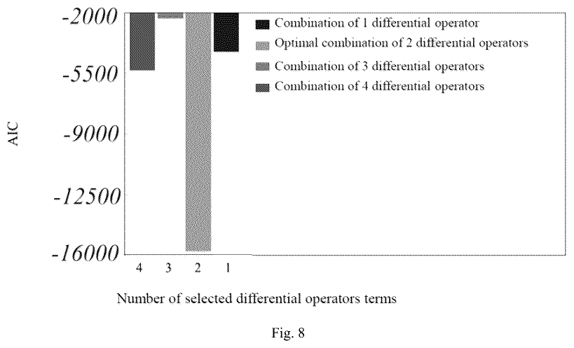

A gap often exists between the idealized wave equation model describing vibration phenomena and the practical situation. Accordingly, the AIC is considered for carrying out model evaluation and selection, and for the wave phenomena, a second derivative with respect to the time variable is considered. The candidates are constructed as follows: Φ=[uₜₜ,uₓ,uₓₓ,uₓₜ]. The AIC in formula (10) is subsequently used for evaluating and selecting an appropriate combination from Φ. FIG. 8 is a histogram of the size of AIC of the number of typical model terms of wave equations describing the wave phenomena. The results show that the combination of uₜₜ and uₓₓ is a optimal combination of differential operators to describe the wave phenomena. The details of the hierarchical coupling strategy for optimizing and coupling and model selection of CPINNRP-AIC are shown in algorithm 1.

### Algorithm 1: Hierarchical Coupling Strategy for Optimizing and Coupling and Model Selection of CPINNRP-AIC:

(1) Initialization: letting k=0, initializing the network NetU and the network NetG, and setting the maximum number k of iteration steps to M as the stop criterion of loop;
1.1) Obtaining a training data set (x,t,u)∈D and a collocation point (x,t)∈E;
1.2) Randomly generating initialized parameter sets Θ_{U}⁽⁰⁾ and Θ_{G}⁽⁰⁾ for the network NetU and the network NetG;
1.3) Conducting the following loop when k<M:
(a1) Obtaining \hat{Θ}_{G}^{(k+1)} by solving the optimization problem (8), and Φ[û(x,t;\hat{Θ}_{U}^{(k)})]·\hat{λ}^{(k)} in MSE_{PN} from the iteration result (\hat{Θ}_{U}^{(K)},\hat{λ}^{(k)}) of the previous step;
(b1) Obtaining (\hat{Θ}_{U}^{(k+1)},\hat{λ}^{(k+1)}) by solving the optimization problem (9), called (\hat{Θ}_{CPINN},\hat{λ}^{(k+1)});
(c1) k=k+1;
Judging whether the stop criterion of loop is met: if yes, ending the loop, and returning to u(x,t;\hat{Θ}_{CPINN}); if no, returning to step (a1), and conducting an iterative transmission process of parameters Θ_{U} and Θ_{G} to solve the optimization problems (8) and (9);
(2) Initialization: letting k=0, and initializing the network NetU-RP using \hat{Θ}_{CPINN};
2.1) Besides x and t, inputting the output u(x,t;\hat{Θ}_{CPINN}) of CPINN and the measurements to NetU-RP in an either-or way by recurrently delayed through time, depending on whether the hardware sensors are available;
2.2) Conducting the following loop when k<M:
(a2) Training NetU-RP using formula (4);
2.3) Judging whether the stop criterio of loop is met: if yes, ending the loop, and returning to differential operator candidates Φ[û(x,t;\hat{Θ}_{U})]·\hat{λ} obtained by means of automatic differentiation; if no, returning to step (a2).
2.4) Calculating the AIC value from the combination Φ[û(x,t;\hat{Θ}_{U})]·\hat{λ} of differential operator candidates using formula (10);
2.5) Selecting a combination of differential operators with the minimum AIC value as a final model for approximating PDEs describing actual vibration processes.
4. Evaluation of Performance

RMSE of formula (11) is used to evaluate the measurement error of the proposed CPINNRP-AIC method in soft sensing of the vibration displacement distribution of the aero-engine involute spline shaft, i.e., evaluating the performance of the CPINNRP-AIC method in solving an unknown exact one-dimensional wave equation structure. RMSE of f_{N}(x,t) for the full time period is 1.053161e-04, and RMSEs of the training set and the test set f_{N}(x,t) are 9.945489e-05 and 1.059776e-04, respectively. u(x,t) and û(x,t) represent the measurement of an actual hardware vibration displacement sensor and a corresponding soft sensing vibration displacement value, respectively. To further verify the performance of the CPINNRP-AIC, CC of formula (12) is used to further illustrate the similarity between the soft sensing vibration displacement of the CPINNRP-AIC method and the measurement of the actual hardware vibration displacement sensor. In the present embodiment, the relevant setting for the CPINNRP-AIC is that the number of hidden layers is 3 and each layer has 10 neurons. Table 2 shows the soft sensing performance of the model obtained by the CPINNRP-AIC for the actual vibration displacement of the aero-engine spline shaft.

Reference example: early work of the research group (Sun Ximing, Wang Aina, Qin Pan, “Coupled Physics-informed Neural Networks for Solving Vibration Displacement Distribution of Finite Line Under the Action of Unknown Driving Forces” [P]. Liaoning Province: CN116050247A, 2023 May 2)

The following idealized wave equation is used to describe the actual vibration processes:

$$\begin{matrix}\frac{{\partial }^{2} u}{\partial {t}^{2}} = {a}^{2} \frac{{\partial }^{2} u}{\partial {x}^{2}} + g ( x , t ) , 0 < x < L , t > 0 \\ u {\vert}_{x = 0} = 0 , u {\vert}_{x = L} = 0 , t > 0 \\ u {\vert}_{t = 0} = 0 , \frac{\partial u}{\partial t} {\vert}_{t = 0} = 0 , 0 ⩽ x ⩽ L\end{matrix} , \qquad ( 15 )$$

The vibration wave speed is α=1, the length is L=π, the vibration wave propagation time is t=6, the driving force in the area(x,t) is

$$g ( x , t ) = sin \frac{2 π x}{L} sin \frac{2 a π t}{L} ,$$

and the vibration displacement is

$$u ( x , t ) = \frac{L}{4 a π} ( \frac{L}{2 a π} - t cos \frac{2 a π}{L} t ) sin \frac{2 π}{L} x .$$

The wave equation representing displacement distribution is converted to a PDE in the residual form as shown in formula (3).

$${f}_{s} ( x , t ) = \frac{{\partial }^{2} u}{\partial {t}^{2}} - {a}^{2} \frac{{\partial }^{2} u}{\partial {x}^{2}} - g ( x , t ) \qquad ( 16 )$$

Therefore, in the benchmark example, the idealized wave equation (15) is used to describe the vibration process of the aero-engine spline shaft. The benchmark example does not involve the processes of evaluating and selecting undetermined differential operators using the AIC of formula (10). The benchmark example uses a CPINN with an RP mechanism to solve the idealized wave equation (15), and the obtained solution û is the soft sensing result of vibration displacement to be obtained. Table 2 shows comparison of the soft sensing performance of the idealized wave equation describing the vibration displacement distribution of the aero-engine involute splines and the model obtained by the CPINNRP-AIC, and the optimal values in Table 2 are shown in bold.

TABLE 2
Comparison of Soft Sensing Performance of Idealized Wave Equation and Model Obtained
by CPINNRP-AIC

| | Evaluation | | | |
|---|---|---|---|---|
| Model | Criterion | Training Set | Test Set | [0, 5.2] × [0, 2] |
| 1-idealized | RMSE | 2.613778e−02 | 5.776048e+00 | 5.201132e−02 |
| (Benchmark | CC | 9.999967e−01 | 9.879768e−01 | 9.983170e−01 |
| example) | | | | |
| 1-CPINNRP-AIC | RMSE | 3.595075e−01 | 3.944919e−01 | 3.937696e−01 |
| (Embodiment 2) | CC | 9.999121e−01 | 9.998993e−01 | 9.998996e−01 |
| 2-idealized | RMSE | 1.088167e−02 | 5.449913e+00 | 5.446586e+00 |
| (Benchmark | CC | 9.999997e−01 | 9.909315e−01 | 9.909329e−01 |
| example) | | | | |
| 2-CPINNRP-AIC | RMSE | 3.439997e−01 | 3.806409e−01 | 3.799071e−01 |
| (Embodiment 2) | CC | 9.999317e−01 | 9.999219e−01 | 9.999220e−01 |
| 3-idealized | RMSE | 9.480886e−03 | 4.762897e+00 | 4.759989e+00 |
| (Benchmark | CC | 9.999998e−01 | 9.933763e−01 | 9.933794e−01 |
| example) | | | | |
| 3-CPINNRP-AIC | RMSE | 4.038952e−01 | 4.015018e−01 | 4.011793e−01 |
| s(Embodiment 2) | CC | 9.999433e−01 | 9.999440e−01 | 9.999441e−01 |
| 4-idealized | RMSE | 2.144921e+00 | 8.222315e+00 | 8.217437e+00 |
| (Benchmark | | | | |
| example) | CC | 9.997592e−01 | 9.714094e−01 | 9.714027e−01 |
| 4-CPINNRP-AIC | RMSE | 7.020737e+00 | 6.975732e+00 | 6.968462e+00 |
| (Embodiment 2) | CC | 9.749890e−01 | 9.748884e−01 | 9.749325e−01 |

RMSE tends to 0 and the CC tends to 1 in Table 2. The soft sensing result in the benchmark example is not as good as the CPINNRP-AIC method proposed by the present invention due to the idealized wave equation is not completely suitable for controlling the actual vibration processes. The early work of the research group was to use the idealized wave equation to describe the actual vibration processes, and the idealized wave equation cannot completely accurately describe the actual vibration processes due to uncertain factors involved in the actual vibration processes. The CPINNRP-AIC method proposed by the present invention adopts the vibration displacement data obtained from the actual vibration processes to obtain the wave equation model that can accurately describe the actual vibration processes by evaluating the AIC of the combination of differential operators. Therefore, the CPINNRP-AIC method proposed by the present invention has higher soft sensing accuracy.

The above embodiments only express the implementation of the present invention, and shall not be interpreted as a limitation to the scope of the patent for the present invention. It should be noted that, for those skilled in the art, several variations and improvements can also be made without departing from the concept of the present invention, all of which belong to the protection scope of the present invention.

1-4. (canceled)

5. A spatiotemporal dynamic system soft sensing method for automatically determining a partial differential equation (PDE) structure, comprising the following steps: firstly, constructing a loss function for training a coupled physics-informed neural network (CPINN) with a recurrent prediction (RP) mechanism to obtain a structure satisfying a PDE used for describing spatiotemporal industrial processes, so as to obtain a solution and a driving source; secondly, obtaining differential operator candidates by an automatic differentiation method; thirdly, selecting an appropriate PDE structure from the differential operator candidates using Akaike's information criterion (AIC) to accurately describe the spatiotemporal industrial processes; and finally, verifying the soft sensing result obtained by the method using heat diffusion phenomena and actual vibration processes;
wherein comprising the following steps:
a PDE used for describing industrial processes with spatiotemporal dependence has the following general form:
$${u}_{r} ( x , t ) + N [ u ( x , t ) ] - g ( x , t ) , x ∈ Ω , t ∈ [ 0 , T ] \qquad ( 1 )$$
wherein x is a space variable, tis a time variable and in the initial state when t=0,
u: [symbol] ^{a}× [symbol] → [symbol] is solution to formula (1), i.e., a variable to be measured of the industrial processes with spatiotemporal dependence, and the variable has spatiotemporal dependence; g: [symbol] ^{d}× [symbol] → [symbol] is a driving source with a general form, i.e., the driving source has spatiotemporal dependence; Ω is open set space to which the space variable belongs, and ωΩ is the boundary thereof; and N is a series of differential operators;
when the exact PDE structure is unknown for the industrial processes with spatiotemporal dependence, the soft sensing method CPINNRP-AIC approximates formula (1) based on the following PDE:
$$Φ [ u ( x , t ) ] \cdot λ = g ( x , t ) , x ∈ Ω ⊆ {ℝ}^{d} , t ∈ [ 0 , T ] ⊂ ℝ , \qquad ( 2 )$$
wherein Φ is differential operator candidates with a series of partial differential operators, i.e., a series of states of the industrial processes with spatiotemporal dependence changing over time and space;
the soft sensing method is to learn to obtain a solution u and a driving source g that can approximately satisfy formula (1) from formula (2); and formula (2) can be written in a form of the following residual function:
$${f}_{N} ( x , t ) : - Φ [ u ( x , t ) ] \cdot λ - g ( x , t ) . \qquad ( 3 )$$
the CPINNRP-AIC comprises two stages: 1) the CPINNRP is for approximating u and g satisfying the PDE in formula (1); 2) the AIC is for selecting an approximate combination of differential operators satisfying the PDE in formula (1); the CPINNRP is composed of NetU, NetG and NetU-RP, wherein NetU is for approximating u satisfying formula (1), NetG is for approximating g satisfying formula (1), and NetU-RP is for compensating for information loss caused by the discretization strategy with respect to t; and the specific steps are as follows:
step 1: constructing a loss function for training the CPINNRP;
a training data set (x,t,u)∈D is obtained using hardware sensors, wherein the hardware sensors comprise a mountable sensor in the interior Ω of a domain and a mountable sensor at the boundary ωΩ of the domain; the dataset is divided into D_{B} ∪D_{I} and D_{E}∩D_{I}−Ø, D_{E} and D_{I} are randomly sampled from boundary and initial conditions of Ω and the interior Ω, respectively, D_{B} represents a training set sampled from the mountable sensor at the boundary ωΩ of the domain and the initial time, and D_{I} represents a training set sampled from the mountable sensor in the interior Ω of the domain; x,t,u represent a space variable, a time variable and a variable to be measured with spatiotemporal dependence, respectively; D represents the training dataset; a corresponding collocation point set E−E_{B} ∪E_{I} is acquired according to the positions of the sensors, wherein (x,t)∈E, and E represents a the whole domain collocation point set; E_{B} represents a collocation point set corresponding to the training dataset D_{B}; and Eᵢ represents a collocation point set corresponding to the training dataset D_{I};
the CPINNRP-AIC is trained using a data-physics-hybrid loss function shown in formula (4);
$$MSE - {MSE}_{DN} + {MSE}_{FN} \qquad ( 4 )$$
wherein MSE_{DN} and MSE_{PN} represent a data loss function and a physics-informed loss function with an undefined exact PDE structure in the given formula (2), respectively, and the physics-informed loss function contains a physics-informed part Φ[u(x,t)]·λ with an undetermined combination of differential operators;
step 2: optimizing the coupled CPINNRP-AIC with an undetermined exact PDE structure using a hierarchical training strategy;
considering the interdependence between the network NetU and the network NetG in formula (4), the hierarchical training strategy is proposed to train the CPINNRP-AIC by means of iterative transmission of parameters, wherein \hat{Θ}_{U}^{(k+1)} and \hat{Θ}_{G}^{(k+1)} obtained are used for approximating u and g, respectively; k represents the number of iteration steps; and the purpose of the hierarchical training strategy is to solve the following two coupled optimization problems;
$$\begin{matrix}{Θ}_{0}^{( k + 1 )} = {arg min}_{{θ}_{G}} ( {MSE}_{DN} ( {Θ}_{U}^{( k )} ) + {MSE}_{FN} ( {Θ}_{G} ; {\hat{Θ}}_{U}^{( k )} , {λ}^{( k )} ) ) \\ = {arg min}_{{Θ}_{G}} {MSE}_{FN} ( {Θ}_{G} ; {\hat{Θ}}_{U}^{( k )} , {λ}^{( k )} )\end{matrix} \qquad ( 8 )$$
$$and$$
$$( {\hat{Θ}}_{V}^{( k + 1 )} , {λ}^{( k + 1 )} ) = {arg min}_{( {Θ}_{U} , λ )} ( {MSE}_{DN} ( {Θ}_{U} ) + {MSE}_{FN} ( {Θ}_{U} , λ ; {Θ}_{G}^{( k + 1 )} ) ) , \qquad ( 9 )$$
wherein MSE_{PN} (Θ_{G};\tilde{Θ}_{U}^{(k)},\hat{λ}^{(k)}) and MSE_{PN} (Θ_{U},λ;\hat{Θ}_{G}^{(k+1)}) are the physics-informed parts with an undetermined combination of differential operators, and MSE_{PN} (Θ_{G};\tilde{Θ}_{U}^{(k)},\hat{λ}^{(k)}) is obtained from (\tilde{Θ}_{U}^{(k)},\hat{λ}^{(k)}) and MSE_{PN} (Θ_{U};λ;\tilde{Θ}_{G}^{(k+1)}) is obtained from \hat{Θ}_{G}^{(k+1)};
To compensate for the information loss caused by discretization strategy with respect to t, the delayed prediction through time of the CPINN output û(x,t;\hat{Θ}_{CPINN}) and hardware sensors are used as part of the NetU-RP input, i.e., the input of NetU-RP comprises three parts: x, t and the delayed prediction through time of û(x,t;\hat{Θ}_{CPINN}) or the delayed prediction through time of hardware sensors; û(x,t;\hat{Θ}_{CPINN}) and the output of the hardware sensors are selected in an either-or way, i.e., when the hardware sensors can be installed at the collocation point (x,t), the delayed output of the measurements is used as the input of the collocation point; and when the measurements of the hardware sensors cannot be obtained at the collocation point (x,t), the delay of û(x,t;\hat{Θ}_{CPINN}) is used as the input of the collocation point;
at this point, Φ[û(x,t;\hat{Θ}_{U})]·\hat{λ} with an undetermined combination of differential operators and g satisfying formula (1) are obtained;
step 3: using the AIC to select an appropriate combination of differential operators satisfying formula (1);
the AIC is used to evaluate and select Φ[û(x,t;\hat{Θ}_{U})]·λ containing an undetermined combination of differential operators:
$$AIC = 2 p + n ln ( {θ}^{2} ) , \qquad ( 10 )$$
wherein p is the number of differential operators contained in Φ[û(x,t;\hat{Θ}_{U})]·\hat{λ}, n is the size of the dataset, and û²=MSE_{DN}; and the selected combination of differential operators achieves the appropriate PDE structure, i.e., a combination with the minimum AIC value is selected from all the candidates Φ[û(x,t;\hat{Θ}_{U})]·\hat{λ} as a PDE model that is ultimately used for approximating formula (1);
step 4: evaluating the performance of the CPINNRP-AIC method in the spatiotemporal dynamic system soft sensing method for automatically determining a PDE structure; and using a root mean square error (RMSE) and a Pearson correlation coefficient (CC) as evaluation criteria to evaluate the performance of the CPINNRP-AIC.

6. The spatiotemporal dynamic system soft sensing method for automatically determining a PDE structure according to claim 5, wherein in formula (4) of step 1:
the MSE_{DN} is obtained by the following formula:
$${MSE}_{DN} = 1 \backslash card ( D ) {\sum }_{( x , t , u ) ∈ D} {( \hat{u} ( x , t ; {Θ}_{U} ) - u ( x , t ) )}^{2} \qquad ( 5 )$$
wherein û(x,t;\hat{Θ}_{U}) is a function of the network NetU with Θ_{U} being a set of parameters to approximate u satisfying formula (1), and card(·) is the cardinalty of the set;
the MSE_{PN} is obtained by the following formula:
$${MSE}_{FN} = 1 \backslash card ( E ) {\sum }_{( x , t ) ∈ D} {( {\hat{f}}_{N} ( x , t ; {Θ}_{U} , λ ) )}^{2} \qquad ( 6 )$$
further, \hat{f}_{N}(x,t;Θ_{U},λ) is obtained from Φ[û(x,t;Θ_{U})]·λ with an undetermined combination of operators, as shown in formula (7):
$${\hat{f}}_{N} ( x , t ; {Θ}_{U} , λ ) = Φ [ \hat{u} ( x , t ; {Θ}_{U} ) ] * λ - \hat{g} ( x , t ; {Θ}_{G} ) \qquad ( 7 )$$
wherein ĝ(x,t;Θ_{G}) is a function of the network NetG with Θ_{G} being a set of parameters to approximate g satisfying formula (1); λ represents a parameter vector; and \hat{f}_{N}(x,t;Θ_{U},λ) represents a residual function form of formula (3) parameterized by (Θ_{U},λ)

7. The spatiotemporal dynamic system soft sensing method for automatically determining a PDE structure according to claim 5, wherein the algorithm 1 of the hierarchical training strategy for optimizing the coupled CPINNRP-AIC shows:
algorithm 1: CPINNRP-AIC for hierarchical optimization coupling strategy and model selection:
(1) initialization: letting k−0, initializing the network NetU and the network NetG, and setting the maximum number k of iteration steps to M as the stop criterion for loop;
1.1) obtaining a training dataset (x,t,u)∈D and a collocation point set (x,t)∈E;
1.2) randomly generating initialized parameter sets Θ_{U}⁽⁰⁾ and Θ_{G}⁽⁰⁾ for the network Nett and the network NetG;
1.3) conducting the following loop when k<M:
(a1) obtaining \hat{Θ}₀^{(k+1)} by solving the optimization problem (8), and Φ[û(x,t;\hat{Θ}_{U}^{(k)}]·λ^{(k)} contained in MSE_{PN} from the iteration result (\hat{Θ}_{U}^{(k)},\hat{λ}^{(k)}) of the previous step;
(b1) obtaining (\hat{Θ}_{U}^{(k+1)},\hat{λ}^{(k+1)}) by solving the optimization problem (9), called (\hat{Θ}_{CPINN},\hat{λ}^{(k+1)});
(c1) k−k+1;
judging whether the stop criterion is met: if yes, ending the loop, and returning to û(x,t;\hat{Θ}_{CPINN}); if no, returning to step (a1), and conducting an iterative transmission process of parameters Θ_{U} and Θ_{G} to solve the optimization problems (8) and (9);
(2) initialization: letting k=U, and initializing the network NetU-RP using \hat{Θ}_{CPINN};
2.1) Besides x and t, inputting the output û(x,t;\hat{Θ}_{CPINN}) of the CPINN and the measurement to NetU-RP in an either-or way by recurrently delayed through time, depending on whether the hardware sensors are available;
2.2) conducting the following loop when k<M:
(a2) training NetU-RP using formula (4);
2.3) judging whether the stop criterion of loop is met: if yes, ending the loop, and returning to differential operator candidates Φ[û(x,t;\hat{Θ}_{U})]·\hat{λ} obtained by means of automatic differentiation; if no, returning to step (a2);
2.4) calculating the AIC value from the combination Φ[û(x,t;\hat{Θ}_{U})]·\hat{λ} of differential operator candidates using formula (10);
2.5) selecting a combination of differential operators with the minimum AIC value as a final model for approximating formula (1).
